(19) United States
(12) Patent Application Publication
(10) Pub. No.: US 2026/0097581 A1
(43) Pub. Date: Apr. 9, 2026

(54) LIQUID EJECTION APPARATUS AND CIRCULATION INSPECTION APPARATUS

(71) Applicant: CANON KABUSHIKI KAISHA, Tokyo (JP)

(72) Inventor: MASAO FURUKAWA, Kanagawa (JP)

(21) Appl. No.: 19/353,236

(22) Filed: Oct. 8, 2025

(30) Foreign Application Priority Data
Oct. 9, 2024 (JP) 2024-177322

(51) Int. Cl. B41J 2/045; B41J 2/18

(52) U.S. Cl. CPC B41J 2/0451; B41J 2/04558; B41J 2/04573; B41J 2/04586; B41J 2/18; B41J 2202/12

(57) ABSTRACT

A liquid ejection apparatus, comprising: a liquid ejection head which has: an ejection orifice row formed by a plurality of ejection orifices that are arranged in a first direction, and a pressure chamber that communicates with the ejection orifice; a circulation unit configured to circulate the liquid inside the pressure chamber between inside and outside of the pressure chamber; a drive control portion being configured to be capable of executing: (i) an ejection suspension operation; (ii) a circulation operation; and (iii) a printing operation to print an elongated inspection pattern in a second direction on a recording medium, by ejecting the liquid a plurality of times from the same ejection orifice; and a circulation inspection unit for inspecting a circulation state of the liquid ejection head on the basis of a length of the inspection pattern in the second direction.

### BACKGROUND

### Field of the Technology

The present disclosure relates to a liquid ejection apparatus and a circulation inspection apparatus.

### Description of the Related Art

As a recording apparatus that records text and an image on a recording medium, there is a liquid ejection apparatus which includes a liquid ejection head provided with an ejection orifice for ejecting a liquid and a pressure chamber that communicates with the ejection orifice. It is known that when the ejection orifice of the liquid ejection head is exposed to the atmosphere, volatile components in the liquid are evaporated from the ejection orifice into the atmosphere over time, and the viscosity of the liquid inside the ejection orifice is increased. When the viscosity of the liquid inside the ejection orifice is increased, the ejection velocity of the ejected liquid droplet decreases during liquid ejection, and the landing accuracy of the liquid droplet may be influenced. In particular, when the time in which the liquid is not ejected (hereinafter referred to as a suspension time) is long, the viscosity of the liquid is significantly increased, and sometimes the ejection orifice may experience poor ejection.

The thickening of the liquid can be inhabited by causing the liquid inside the pressure chamber to circulate. Japanese Patent No. 7463171 discloses an inspection method in which a liquid is ejected from a plurality of linearly arranged ejection orifices to print a linear printing pattern extending in an arrangement direction, and a circulation state of the liquid is inspected on the basis of the printing pattern.

### SUMMARY

An object of the present disclosure is to further develop conventional technology.

According to some embodiments, the liquid ejection head of the present disclosure is characterized by features including:
a liquid ejection head which has: an ejection orifice row formed by a plurality of ejection orifices that are arranged in a first direction and for ejecting a liquid, and a pressure chamber that communicates with the ejection orifice and has a pressure generation element configured to generate a pressure for ejecting a liquid from the ejection orifice;
a circulation unit configured to circulate the liquid inside the pressure chamber between inside and outside of the pressure chamber;
a drive control portion which controls operations of the liquid ejection head and the circulation unit, the drive control portion being configured to be capable of executing: (i) an ejection suspension operation to suspend liquid ejection from the ejection orifice; (ii) a circulation operation to circulate the liquid inside the pressure chamber that communicates with the ejection orifice between the inside and outside of the pressure chamber; and (iii) a printing operation to print an elongated inspection pattern in a second direction intersecting the first direction on a recording medium, by ejecting the liquid a plurality of times from the same ejection orifice; and a circulation inspection unit for inspecting a circulation state of the liquid ejection head on the basis of a length of the inspection pattern in the second direction.

Features of the present disclosure will become apparent from the following description of embodiments with reference to the attached drawings. The following description of embodiments is described by way of example.

### BRIEF DESCRIPTION OF THE DRAWINGS

FIG. 1A to FIG. 1D are perspective views illustrating a liquid ejection head and an element substrate, where FIG. 1A is a perspective view illustrating a liquid ejection head, FIG. 1B is a perspective view illustrating a liquid ejection head in a form different from the example illustrated in FIG. 1A, FIG. 1C is a perspective view illustrating a liquid ejection head in a form different from the examples illustrated in FIG. 1A and FIG. 1B, and FIG. 1D is an enlarged perspective view illustrating an element substrate H;

FIG. 2 is a perspective view illustrating a circulation inspection apparatus;

FIG. 3 is a flowchart illustrating an inspection flow of liquid circulation inspection of a first embodiment;

FIG. 4A and FIG. 4B are diagrams illustrating an inspection pattern of the first embodiment, where FIG. 4A is a schematic diagram of all inspection patterns printed using all ejection orifices of an element substrate, and FIG. 4B is a schematic diagram of an inspection pattern (vertical ruled line) printed with one ejection orifice;

FIG. 5 is a flowchart illustrating an evaluation flow of the inspection pattern of the first embodiment;

FIG. 6A to FIG. 6C are schematic diagrams of an image processing procedure of the inspection pattern of the first embodiment, where FIG. 6A is a partially enlarged diagram of an example of a state within an image processing region, FIG. 6B is a schematic diagram of a state after dot clusters are extracted from the state of FIG. 6A, and FIG. 6C is a diagram illustrating a state after the processing of S503 is completed, with respect to FIG. 6B;

FIG. 7A and FIG. 7B are diagrams illustrating the length of the inspection pattern of the first embodiment;

FIG. 8 is a diagram illustrating an inspection pattern of a second embodiment;

FIG. 9 is a flowchart illustrating an evaluation flow of an inspection pattern of a third embodiment;

FIG. 10A to FIG. 10D are explanatory diagrams of a method for calculating grid coordinates of the inspection pattern of the third embodiment, where FIG. 10A is a schematic diagram illustrating a state after execution of vertical ruled line centroid acquisition processing of S507, FIG. 10B is a schematic diagram illustrating a state after execution of first grouping, FIG. 10C is a schematic diagram illustrating a state after execution of second grouping, and FIG. 10D is a diagram illustrating a state after the centroid is annotated in the form of e(m, n); and

FIG. 11 is an explanatory diagram of a method for calculating an amount of mis-alignment of the inspection pattern of the third embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

### Liquid Ejection Head

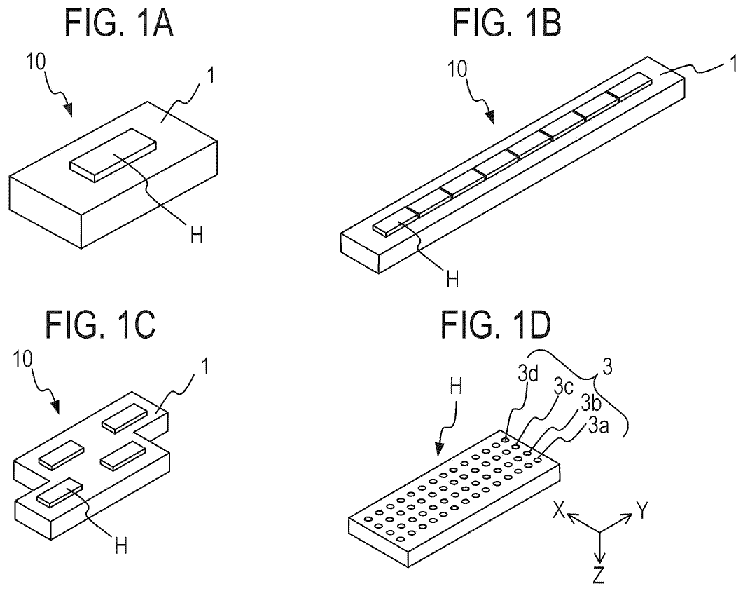

First, a liquid ejection head, which is the inspection target, of a circulation inspection apparatus according to the present disclosure will be described. FIG. 1A to FIG. 1D are views illustrating examples of a liquid ejection head 10 that can be inspected by a circulation inspection apparatus.

FIG. 1A is a perspective view illustrating a liquid ejection head 10. The liquid ejection head 10 includes an element substrate H that ejects an ink as a liquid, and a support member 1 that supports the element substrate H. In the liquid ejection head 10 of this example, as for one element substrate H, one support member 1 is arranged. When viewed in the thickness direction of the element substrate H, the element substrate H and the support member 1 are each rectangular in shape.

The element substrate H is bonded to the support member 1 with a layer of an adhesive agent (not illustrated) therebetween. The support member 1 is provided with a supply port (not illustrated) for supplying a liquid to the inside of the support member 1, and a discharge port (not illustrated) for discharging a liquid from the support member 1, with a flow passage formed inside to supply and discharge the liquid to and from the element substrate H.

FIG. 1B is a perspective view illustrating a liquid ejection head 10 in a form different from the example illustrated in FIG. 1A. In the liquid ejection head 10 of this example, as for one support member 1, eight element substrates H are linearly arranged thereon, enabling wide width printing to be carried out with one operation. FIG. 1C is a perspective view illustrating a liquid ejection head 10 in a form different from the examples illustrated in FIG. 1A and FIG. 1B. In the liquid ejection head 10 of this example, as for one support member 1, four element substrates H are arranged in a staggered manner. Moreover, the support member 1 of this example is not rectangular in shape when viewed in the thickness direction of the element substrate H, but is of a shape in which protruding portions protruding outwards relative to each of the two sides of the rectangle are provided. As in the configuration examples illustrated in FIG. 1A to FIG. 1C, the number of element substrates H mounted on a liquid ejection head 10 to be inspected by the circulation inspection apparatus may be any number.

FIG. 1D is an enlarged perspective view illustrating an element substrate H. The element substrate H includes a plurality of ejection orifices 3 for ejecting a liquid. The ejection orifices 3 are arranged in rows extending along the longitudinal direction of the element substrate H, and constitute four ejection orifice rows in total. The four ejection orifice rows composed of the plurality of ejection orifices 3 are defined as ejection orifice rows 3a, 3b, 3c and 3d, respectively. The four ejection orifice rows 3a, 3b, 3c and 3d are arranged in this order in the transverse direction that intersects the longitudinal direction of the element substrate H (in this example, the transverse direction is the orthogonal direction). In the following description, the longitudinal direction of the element substrate H, that is, the arrangement direction of the ejection orifices 3, is defined as the Y direction; the transverse direction of the element substrate H, that is, the direction in which the ejection orifice rows 3a, 3b, 3c and 3d are arranged (adjacent), is defined as the X direction; and a direction orthogonal to both the Y direction and the X direction is defined as the Z direction.

In this example, 128 ejection orifices 3 are arranged in each of the ejection orifice rows 3a to 3d. However, in FIG. 1D, for simplification, the illustration of some ejection orifices 3 are omitted, and fewer ejection orifices 3 than the actual number are drawn. Note that the number of rows of ejection orifice rows is not limited to four and may be any number, and the number of ejection orifices 3 arranged in one row of the ejection orifice rows is not limited to 128 and may be any number.

The element substrate H further includes a pressure chamber that communicates with the ejection orifice 3, a supply port for supplying a liquid to the pressure chamber, and a pressure generation element that generates a pressure for ejecting the liquid. These components are provided inside the element substrate H and are not illustrated in the figures. In the element substrate H, one pressure chamber is provided corresponding to one ejection orifice 3. Then, the liquid inside the pressure chamber is ejected from the ejection orifice 3 by means of the pressure generated by the pressure generation element.

The liquid inside the pressure chamber is circulated between the inside and outside of the pressure chamber for the purpose of inhabiting the liquid from thickening due to the evaporation of the liquid (water or the like) from the ejection orifice 3. That is, the liquid ejection head 10 is configured to allow the circulation of the liquid in order to control the viscosity of the liquid therein.

### Circulation Inspection Apparatus

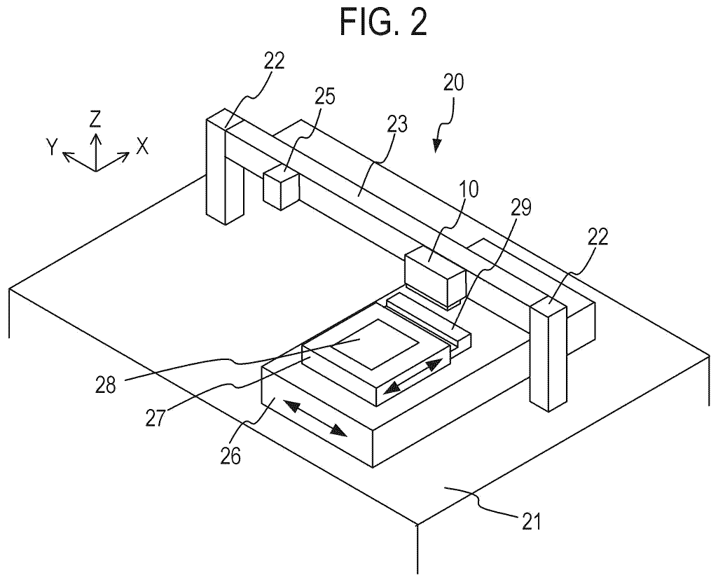

Next, a circulation inspection apparatus 20 for inspecting a circulation state of the liquid ejection head 10 will be described. FIG. 2 is a perspective view illustrating a schematic configuration of the circulation inspection apparatus 20. The circulation inspection apparatus 20 includes a surface plate 21, two support columns 22 disposed on the surface plate 21, and a beam 23 extending horizontally between the two support columns 22. The circulation inspection apparatus 20 further includes a camera 25, which acts as a reading means that reads an inspection pattern, and an image processing portion (image processing apparatus) (not illustrated) that evaluates the inspection pattern read by the camera 25. The liquid ejection head 10, which is the inspection target, and the camera 25, which faces downward, are attached to the beam 23. The liquid ejection head 10 is disposed such that the arrangement direction (Y direction) of the ejection orifices 3 is parallel to the direction in which the beam 23 extends. That is, the surface plate 21, the support columns 22, and the beam 23 constitute a support portion that supports the liquid ejection head 10 and the camera 25.

A Y stage 26 capable of moving in the Y direction between the support columns 22 is mounted on the surface plate 21, and an X stage 27 capable of moving in the X direction is mounted on the Y stage 26. A recording medium 28 onto which the liquid is ejected from the liquid ejection head 10 is fixed onto the X stage 27 by suction. In the recording operation (printing operation) of the liquid ejection head 10, the recording medium 28 is moved relative to the liquid ejection head 10 in the X direction. The material and shape of the recording medium 28 are not particularly limited, as long as the inspection pattern for circulation inspection can be recorded (printed) without a problem.

A liquid receiver 29 for receiving the liquid that is ejected from the liquid ejection head 10 but not caused to land on the recording medium 28 is fixed to the X stage 27. Note that the liquid not caused to land on the recording medium 28 is, for example, the liquid that is ejected in the process of step (hereinafter, “S”) 303, which will be described later.

When the circulation state of the liquid ejection head 10 is inspected, the Y stage 26 is moved to below the liquid ejection head 10, and the inspection pattern is printed on the recording medium 28 by driving the X stage 27 and ejecting the liquid by the liquid ejection head 10 in a synchronized manner. Thereafter, the Y stage 26 and the X stage 27 are driven so as to position the inspection pattern below the camera 25. Then, the inspection pattern printed on the recording medium 28 is read by the camera 25, and the read inspection pattern is evaluated by an image processing apparatus, which serves as the image processing portion, to inspect the circulation state.

The circulation inspection apparatus 20 includes a control portion (not illustrated), and the control portion includes a drive control portion capable of causing the liquid ejection head 10 to carry out a recording operation (printing operation) and of causing the camera 25 to carry out an image reading operation, and an image processing portion (image processing apparatus) capable of executing processing and evaluation of the inspection pattern. The control portion can be composed of, for example, a processor, a memory, a storage, and the like. In such case, the functions of the control portion can be realized by the processor executing a program stored in the memory or the storage. In addition, the image processing portion for processing the inspection pattern may not be incorporated into a part of the control portion. Furthermore, the circulation inspection apparatus 20 may be configured independently as a separate apparatus, or may be incorporated as a part of the configuration or function of a liquid ejection apparatus such as a printer.

The circulation inspection system that inspects the circulation state of the liquid ejection head 10 by the circulation inspection apparatus 20 described above will be described separately in several embodiments.

### First Embodiment

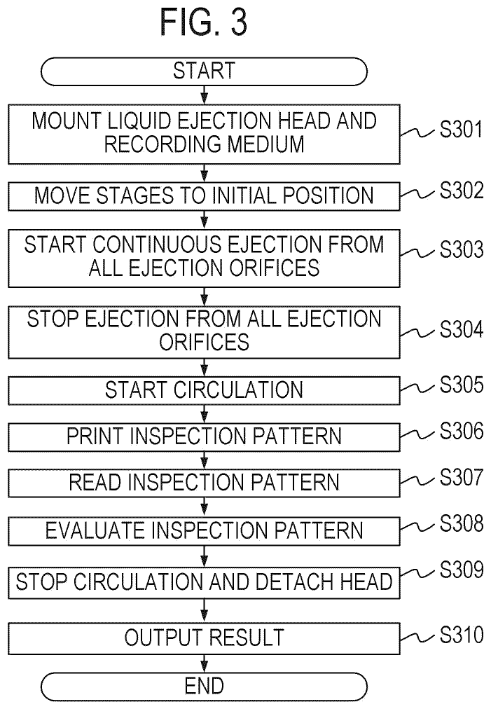

A first embodiment of an inspection system that inspects a circulation state will be described with reference to FIG. 3 to FIG. 7B.

### Circulation Inspection of Liquid

First, an inspection method for inspecting a circulation state of a liquid inside a pressure chamber according to the present embodiment will be described with reference to the liquid ejection head 10 having the configuration illustrated in FIG. 1A as an example. FIG. 3 is a flowchart illustrating the inspection method (inspection flow) for inspecting the circulation state of the liquid in the present embodiment.

First, in S301, a liquid ejection head 10, which is the inspection target, is mounted on a circulation inspection apparatus 20, and a recording medium 28 is mounted on an X stage 27.

Next, in S302, the stages (X stage 27 and Y stage 26) are moved to a predetermined initial position. The initial position refers to such a position where a liquid receiver 29 fixed to the X stage 27 is disposed directly below the liquid ejection head 10.

Next, in S303, continuous ejection of liquid droplets from all the ejection orifices 3 is started, and a continuous ejection process of the liquid is executed. At this time, the liquid droplets ejected from each ejection orifices 3 are collected by the liquid receiver 29 and will not land on the recording medium 28.

By executing the processing of S303, all the ejection orifices 3 can be brought into a state in which the liquid is normally ejected. This is because, even if the ejection orifice 3 experiences poor ejection due to, for example, poor liquid circulation, the thickened liquid inside the ejection orifice will be ejected into the liquid receiver 29 by continuously ejecting the liquid from the ejection orifice 3, and the ejection orifice 3 will be refilled with fresh liquid. That is, by executing S303, only liquid with a viscosity allowing for normal ejection exists inside the ejection orifice 3. In other words, S303 is a viscosity control process (viscosity adjustment process) that controls (adjusts) the viscosity of the liquid so that a liquid with a low viscosity exists inside the ejection orifice 3. That is, it can be said that the circulation inspection apparatus 20 has a viscosity control means that controls the viscosity of the liquid inside the liquid ejection head 10. In the present embodiment, the control portion that controls the operation of the liquid ejection head 10 functions as the viscosity control means.

In S303, the operation of continuously ejecting the liquid from all the ejection orifices 3 is carried out in order to bring the ejection orifices into a state of normal ejection, but the present embodiment is not limited thereto. That is, any processing that can bring the ejection orifice 3 into a state of normal ejection can serve as an alternative to the continuous ejection process of S303. For example, a cap member (not illustrated) may be attached to the element substrate H to suck the inside of the element substrate H, and by releasing the liquid inside the ejection orifice 3 to the outside, the viscosity inside the ejection orifice 3 may be reduced to a low viscosity, thereby bringing the ejection orifice into a state where normal ejection is possible.

After a predetermined period of time has elapsed since the start of liquid ejection, in S304, liquid ejection is stopped, and a period during which ejection is suspended (ejection suspension process) begins. During this period (process), all the ejection orifices 3 enter a suspension time (suspension period) in which no ejection is carried out, and the liquid inside the ejection orifice is thickened due to evaporation of the volatile components in the liquid. That is, by carrying out S304, the viscosity of the liquid inside the ejection orifice is increased. In other words, S304 is an ejection suspension process and can be said to be a viscosity control process for controlling the viscosity of the liquid.

In the present embodiment, the suspension time is set to 2 minutes, but it may be changed appropriately depending on the diameter of the ejection orifice 3, the components of the liquid, and the like. In addition, in order to shorten the suspension time, an air blow nozzle may be used to spray air toward the ejection orifice 3 to promote evaporation of the volatile components in the liquid. In other words, it can be said that the circulation inspection apparatus 20 has an ejection suspension means that suspends ejection from the liquid ejection head 10. In the present embodiment, the control portion that controls the operation of the liquid ejection head 10 functions as the viscosity control means capable of executing an ejection suspension operation to suspend ejection.

After the suspension time has elapsed, in S305, a circulation process for causing the liquid inside the pressure chamber that communicates with the ejection orifice 3 to circulate is started. At this time, if the liquid circulation function is normal, even if liquid ejection from the ejection orifice 3 is suspended, the liquid inside the pressure chamber connected to the ejection orifice 3 is circulated to the outside of the pressure chamber, resulting in a negligible degree of thickening of the liquid inside the ejection orifice 3.

Note that in the present embodiment, the circulation process is carried out after the ejection suspension process, but the present invention is not limited to such a method. For example, the viscosity control operation in S303 (viscosity control process) and the ejection suspension operation in S304 (ejection suspension process) may be carried out while the liquid circulation operation is carried out. As a circulation unit that circulates the liquid in the circulation process, for example, a pump can be used. In addition, during the circulation operation, the operation of the circulation unit is controlled by the control portion.

The circulation unit for circulating the liquid inside the pressure chamber may be provided in the circulation inspection apparatus 20 independently of the liquid ejection head 10, for example, or may be directly provided in the liquid ejection head 10. However, in order to inspect the liquid ejection head 10 used in a liquid ejection apparatus provided with an independent circulation unit, it is necessary to provide a circulation unit in the circulation inspection apparatus 20. In a case where the circulation inspection apparatus 20 is provided with a circulation unit, it is preferable that the circulation unit is the same as the circulation unit provided in the liquid ejection apparatus in which the liquid ejection head 10 is used. In the description of the present specification, even in the case where the circulation unit is mounted on the liquid ejection head 10, the circulation inspection apparatus 20 will be described as including the circulation unit.

Next, in S306, an inspection pattern is printed on the recording medium 28. In the printing process of the inspection pattern, the Y stage 26 and the X stage 27 are driven to move the recording medium 28 to below the liquid ejection head 10. In addition, the printing of the inspection pattern is carried out by ejecting a liquid toward the recording medium 28 a plurality of times from the same ejection orifice 3 while the recording medium 28 is moved relative to the liquid ejection head 10 in the X direction. Details of the inspection pattern will be described later.

Next, in S307, the inspection pattern printed on the recording medium 28 is read. In the inspection pattern reading process, the Y stage 26 and the X stage 27 are driven, and the printed inspection pattern is read by the camera 25. Then, in S308, the read inspection pattern is evaluated. In the present embodiment, either a normal or an abnormal result is obtained as the evaluation result of the inspection pattern.

In S309, circulation of the liquid inside the pressure chamber is stopped, and then the liquid ejection head 10 is detached from the circulation inspection apparatus 20.

In S310, whether the pattern evaluation result in S308 is normal or abnormal is displayed, thereby ending the circulation inspection of the liquid inside the pressure chamber. The evaluation result may be displayed on, for example, a monitor provided in the circulation inspection apparatus 20, or a control portion may display the evaluation result on another terminal. In addition, a notifier for notifying a user of the evaluation result is not limited to a monitor or the like, and for example, a user can also be notified of an abnormality by means of a sound.

### Inspection Pattern

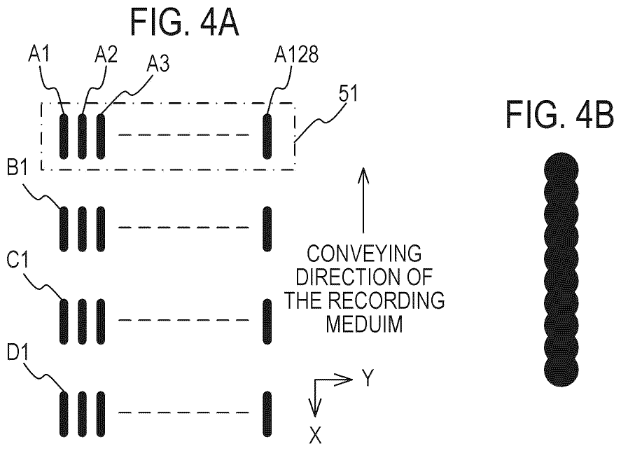

Next, the inspection pattern printed in S306 and an inspection pattern evaluation method of S308 will be described with reference to FIG. 4A to FIG. 7B. In order to explain the inspection pattern, first, the ejection orifice row of the liquid ejection head 10 and the diameter of a landed dot to be inspected in the present embodiment will be described.

The ejection orifice row is formed by 128 ejection orifices 3 arranged at a resolution of 150 dpi. Accordingly, the distance between the centers of the adjacent ejection orifices 3 in the Y direction is about 169 micrometers. In addition, the diameter of the dot that lands on the recording medium 28 may vary depending on the material of the liquid and the material of the recording medium, but in the present embodiment, it is about 50 micrometers. Therefore, even in the case where the liquid is ejected simultaneously from adjacent ejection orifices 3, the 2 landed droplets (landed dots) will not overlap.

FIG. 4A and FIG. 4B are explanatory diagrams of an inspection pattern according to the first embodiment. FIG. 4A is a schematic diagram of all inspection patterns printed using all the ejection orifices 3 of the element substrate H. The inspection pattern is of an elongated linear pattern extending in a direction intersecting the direction (Y direction, first direction) in which the ejection orifice row 3a extends, that is, in the conveying direction (X direction, second direction) of the recording medium. Hereinafter, such a linear shape inspection pattern will be referred to as a vertical ruled line in the following description. In FIG. 4A, 128 vertical ruled lines A1 to A128 printed by means of (each ejection orifice 3 of) the ejection orifice row 3a are illustrated. Similarly, 128 vertical ruled lines B1 to B128 printed by means of the ejection orifice row 3b, 128 vertical ruled lines C1 to C128 printed by means of the ejection orifice row 3c, and 128 vertical ruled lines D1 to D128 printed by means of the ejection orifice row 3d are illustrated in FIG. 4A.

The vertical ruled line A1 is a vertical ruled line printed by means of the ejection orifice 3 located at one end in the Y direction (on the start point side of an arrow indicating the Y direction) among the ejection orifices 3 forming the ejection orifice row 3a. In addition, the vertical ruled line A128 is a vertical ruled line printed by means of the ejection orifice 3 located at the other end in the Y direction (on the end point side of the arrow indicating the Y direction) among the ejection orifices 3 forming the ejection orifice row 3a. The inspection pattern (vertical ruled line) is a pattern independent for each ejection orifice, for example, it is not a pattern formed in a grid shape such that vertical and horizontal lines intersect.

Next, details of the inspection pattern (vertical ruled line) will be described. FIG. 4B is a schematic diagram of an inspection pattern (vertical ruled line) printed by means of one ejection orifice 3. The inspection pattern illustrated in FIG. 4B is an ideal pattern, and in the printing process of S306, the circulation inspection apparatus 20 is driven to print the inspection pattern as illustrated in FIG. 4B. Then, in the printing process of S306, vertical ruled lines A1 to A128 are printed by driving the ejection orifice row 3a. All the ejection orifices 3 of the liquid ejection head 10 are driven to print the pattern illustrated in FIG. 4B.

The vertical ruled line is formed by continuously carrying out 10 ejection operations from the same ejection orifice 3. More specifically, the vertical ruled line is formed by connecting 10 landed droplets (liquid) that land on the recording medium 28 with each ejection operation in such a way that they overlap in the X direction. The specific shape of the vertical ruled line may vary depending on the conveying speed of the recording medium, the ejection time interval, the amount of the ejected liquid (the diameter of the flying liquid droplet), the viscosity of the liquid, the material of the recording medium, and the like. In order to ensure that adjacent landed droplets are reliably connected to each other, it is preferable to set the overlapping length to about one fourth to one half of the diameter of the landed droplet, more preferably about one third of the diameter.

To make one third of the landed droplets adjacent to each other overlap, this can be achieved by ejecting a liquid at an ejection time interval T shown below. In the case where the spread rate determined by the viscosity of the liquid being used and the material of the recording medium is denoted as M, the conveying speed of the recording medium 28 is denoted as V, and the ejection amount is denoted as P, the ejection time interval T for continuous ejection is calculated from the following Math. 1.

$$T = 8.3 M \sqrt[3]{P} / V \qquad [ Math . 1 ]$$

The units of the respective symbols are given as follows: ejection time interval T in microseconds, ejection amount P in picoliters, and conveying speed V of the recording medium 28 in meters per second. Note that the spread rate M is the ratio of the diameter of a flying liquid droplet to the diameter of a landed dot, which is represented by the diameter of a landed dot/the diameter of a flying liquid droplet, and is unitless (dimensionless quantity).

In the present embodiment, since the ejection amount P is set to 2 picoliters, the conveying speed V of the recording medium 28 is set to 0.7 meters per second, and the spread rate M is set to 3, the vertical ruled line is printed with the ejection time interval T of about 45 microseconds. Note that in order to make one half of the diameter of the adjacent landed droplets overlap, the ejection time interval T may be set to about 34 microseconds, and in order to make one fourth of the diameter of the adjacent landed droplets overlap, the ejection time interval T may be set to about 50 microseconds. Accordingly, in the present embodiment, the desired vertical ruled line can be printed by setting the ejection time interval to between 34 and 50 microseconds.

In addition, the length L of the vertical ruled line formed by 10 landed droplets with one third of the adjacent landed droplets overlap is calculated from the following Math. 2.

$$L = 87.1 M \sqrt[3]{P} \qquad [ Math . 2 ]$$

The units of the respective symbols are given as follows: length L in micrometers, and the spread rate M and the ejection amount P are the same as those described above. Note that the reason why the number of liquid droplets used to form the vertical ruled line is set to 10 will be described later.

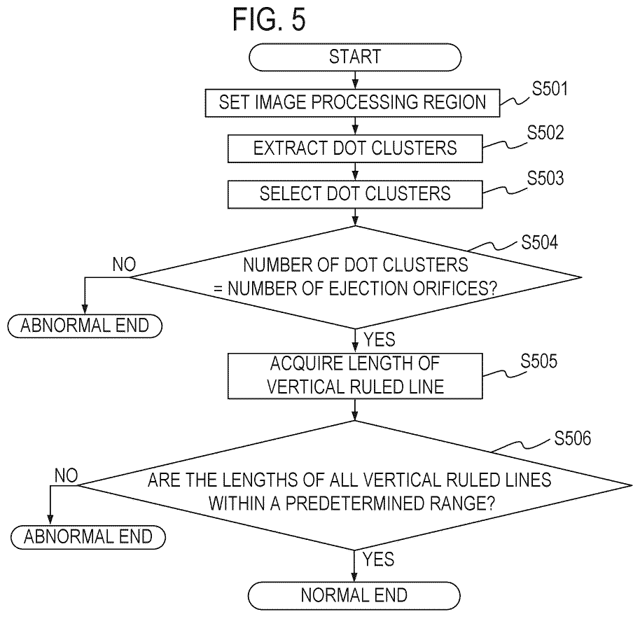

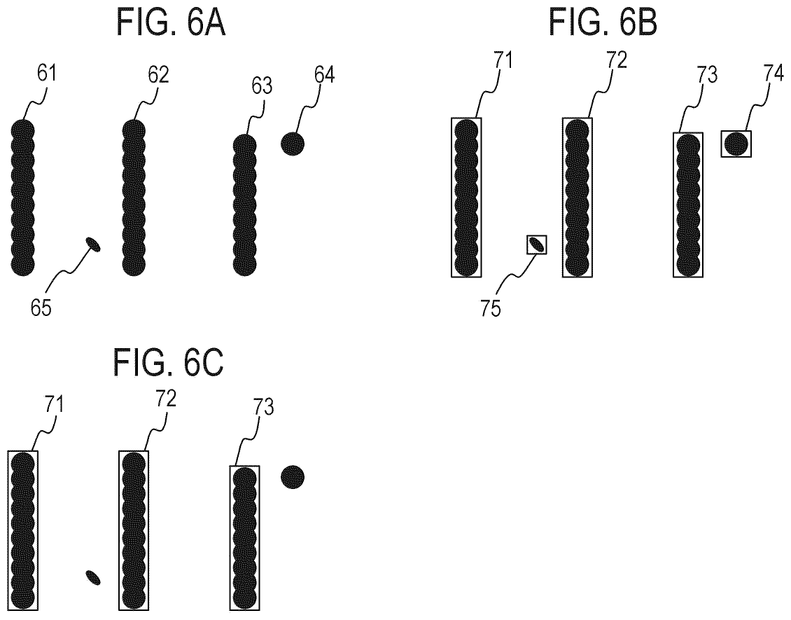

Next, the inspection pattern evaluation method of S308 will be described. The evaluation of the inspection pattern is carried out by performing image processing on data obtained by capturing the pattern and taken same as an image. FIG. 5 is a flowchart illustrating an evaluation flow of the inspection pattern according to the first embodiment. FIG. 6A to FIG. 6C are schematic diagrams of an image processing procedure according to the flowchart of FIG. 5, illustrating an example of the inspection patterns printed with the liquid ejected from the ejection orifice row 3a. Hereinafter, the processing of the inspection patterns printed by means of the ejection orifice row 3a will be described, but the processing procedure for the other ejection orifice rows 3b to 3d is the same. Note that in the present embodiment, the image processing portion functions as a circulation inspection unit that inspects the circulation state of the liquid ejection head by processing the image of the inspection pattern, but the present invention is not limited to such a configuration, and other control portions and the like may also play the role.

First, in S501, the image processing portion sets a region to be subjected to image processing from all the inspection patterns. In the evaluation of the ejection orifice row 3a, the inspection patterns subjected to image processing are the vertical ruled lines A1 to A128. Accordingly, the image processing region is a region that fully contains the entirety of the vertical ruled lines A1 to A128 (slightly larger than the entire area of the vertical ruled lines A1 to A128). In FIG. 4A, an image processing region 51 is indicated by a dash-dotted line. The image processing region 51 is a rectangular region enclosing all 128 vertical ruled lines A1 to A128.

FIG. 6A is a partially enlarged diagram of an example of a state within the image processing region 51. Reference signs 61 to 63 in the figure denote printed vertical ruled lines, reference sign 64 denotes a single (one droplet) landed dot, and reference sign 65 denotes foreign matter attached to the surface of the recording medium. On the recording medium, in addition to the landed dots, sometimes a part of the material that constitutes the recording medium (for example, fibers or the like when the recording medium is paper) or foreign matter such as a small dust particle is attached. Note that the details regarding the existence of the single landed dot 64 will be described later.

Next, in S502, the image processing portion carries out extraction processing for extracting a cluster of landed dots (dot cluster) within the image processing region 51. As mentioned previously, vertical ruled lines A1 to A128 exist within the image processing region 51. Since these vertical ruled lines A1 to A128 are formed by aggregation of overlapping landed dots into clusters, all dot clusters need to be extracted first. FIG. 6B is a schematic diagram of a state after dot clusters are extracted from the state of FIG. 6A. Reference signs 71 to 75 in the figure represent regions extracted as dot clusters. As illustrated in FIG. 6B, in addition to the vertical ruled lines 61 to 63, a single landed dot 64 and foreign matter 65 may also be extracted as dot clusters. Therefore, the number of dot clusters extracted in S502 may be greater than the number of vertical ruled lines (128 in this example).

Next, in S503, the image processing portion carries out selection processing (exclusion processing) for selecting the dot clusters extracted in S502. In S502, the single landed dot 64, foreign matter 65 and the like that are not vertical ruled lines are also extracted as dot clusters, so in S503, processing of excluding these dot clusters from the inspection targets is carried out. Specifically, the image processing portion calculates the area of each dot cluster extracted in S502, and excludes the dot cluster whose area does not reach a predetermined area. In the present embodiment, a dot cluster whose area does not reach half (50%) of the area of an expected (ideal) dot cluster is excluded.

FIG. 6C illustrates a state after the processing of S503 is completed, with respect to FIG. 6B. In S503, it is determined that the respective areas of the dot cluster 74 and the dot cluster 75 recognized as the dot clusters in the processing of S502 (the state of FIG. 6B) are less than the predetermined area, so that they are excluded from the dot clusters. Therefore, only the dot clusters 71 to 73 remain in FIG. 6C.

Note that in the present embodiment, whether a dot cluster could be the inspection target or not is determined on the basis of the area of the dot cluster, but the present invention is not limited to such a configuration. For example, the length of the long side may be used instead of the area of the dot cluster.

Next, in S504, the image processing portion determines whether or not the number of dot clusters within the image processing region 51 is consistent with the number of ejection orifices 3. At the time point when the processing of S503 is completed, all of those recognized as dot clusters are vertical ruled lines (inspection patterns). Accordingly, in the case where the printing of the inspection patterns has been done correctly, there should be 128 dot clusters within the image processing region 51, which number is the same as the number of the ejection orifices 3 in the ejection orifice row. If the number of dot clusters is less than 128 (NO in S504), the image processing portion determines that there is an ejection orifice experiencing poor ejection, and abnormally ends the evaluation flow. On the contrary, if the number of dot clusters is greater than 128 (NO in S504), the image processing portion determines that some malfunction has occurred, and abnormally ends the evaluation flow. In the case of an abnormal end, in the result output processing of S310, the user is notified of the abnormal end, specifically, the user is notified that there is an ejection orifice experiencing poor ejection, or the like. In addition, in the case where the number of dot clusters equals the number of ejection orifices (=128) (YES in S504), the process proceeds to S505 and the evaluation flow continues.

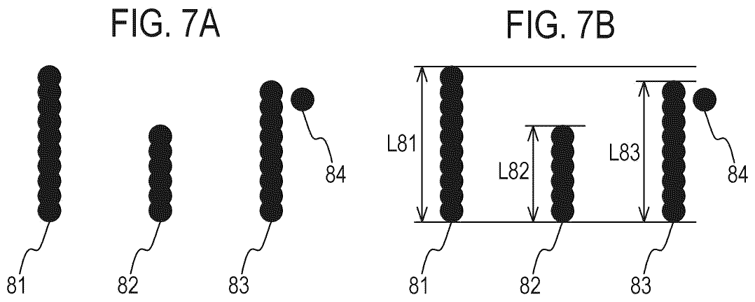

Next, in S505, the image processing portion acquires the length of each vertical ruled line within the image processing region 51. A method for acquiring the length of a vertical ruled line will be described with reference to examples of the inspection patterns illustrated in FIG. 7A and FIG. 7B. FIG. 7A and FIG. 7B are explanatory diagrams of a method for acquiring the length of an inspection pattern, illustrating examples of the inspection patterns that are different from those illustrated in FIG. 6A to FIG. 6C.

FIG. 7A is an example of a partial enlargement diagram of the image processing region 51. FIG. 7A illustrates three vertical ruled lines 81 to 83 out of the 128 printed vertical ruled lines, as well as a liquid droplet 84. All three vertical ruled lines 81 to 83 are in a state in which liquid droplets have landed on the recording medium 28 by carrying out 10 ejection operations at a time interval of the Math. 1. The vertical ruled line 81 is an example of an inspection pattern formed by ejecting a liquid from the ejection orifice 3, with all 10 droplets in all 10 ejection operations landing on the recording medium 28. The length L81 of the vertical ruled line 81 is substantially identical to the value calculated from Math. 2. However, since there is a certain degree of variability in the actual ejection amount and spread rate, the difference between the actual length L and the calculated value is expected to be within 5 percent.

The vertical ruled line 82 is an example of an inspection pattern formed of six droplets, namely, the fifth to tenth droplets, out of 10 ejection operations, with the first to fourth droplets not landing on the recording medium. Accordingly, the length L82 of the vertical ruled line 82 is less than the value calculated from Math. 2, and thus it is determined as poor printing in the present embodiment.

In the case where an inspection pattern such as a vertical ruled line 82 is formed, since the first to fourth droplets have not landed, it can be said that the ejection operations are not carried out normally until the fourth operation. From the fifth droplet onwards, the liquid is ejected from the ejection orifice 3. Accordingly, it can be determined that poor liquid circulation has occurred, and the thickened liquid remains in the ejection orifice 3, but the thickened liquid moves during the repeated ejection operations and then normal ejection can be achieved. Assuming that in the case where none of the 10 droplets have landed, it can be determined that the ejection orifice experiences poor ejection due to factors other than liquid circulation, such as clogging of the ejection orifice with foreign matter. Accordingly, it is determined that there is poor liquid circulation in the ejection orifice 3 used for printing the vertical ruled line 82.

As in this example, in the case where there is poor liquid circulation, even if normal ejection cannot be carried out at the beginning of the ejection, normal ejection often becomes possible with repeated ejection operations. Although the number of ejection operations before normal ejection varies depending on the viscosity and diameter of the ejection orifice, in the configuration of the present embodiment, 10 ejection operations are carried out to determine whether the malfunction is due to poor liquid circulation or a defective other than poor liquid circulation.

The vertical ruled line 83 shows a state in which the second to tenth droplets out of the 10 ejected droplets constitute the vertical ruled line. Its length L83 is less than the value calculated from Math. 2, and thus it is determined as poor printing.

The liquid droplet 84 is a liquid droplet that is ejected and has landed as a result of the initial ejection operation when the vertical ruled line 83 is printed. In the case where the ejection velocity of the liquid droplets is lower than normal and the ejection direction is slightly deviated due to a poor ejection state, some of the liquid droplets like the liquid droplet 84 may not overlap with other liquid droplets and do not form the vertical ruled line 83. Under the condition of insufficient liquid circulation, such abnormal ejection may occur, but with repeated ejection operations, normal ejection can be achieved.

Both the vertical ruled line 82 and the vertical ruled line 83 (and the liquid droplet 84) are formed due to poor liquid circulation, but it can be said that in terms of defect severity, the vertical ruled line 83 is milder than the vertical ruled line 82.

Finally, in S506, the image processing portion determines whether or not the lengths of all vertical ruled lines A1 to A128 are within a predetermined range. Specifically, it is determined whether or not the lengths of 128 vertical ruled lines A1 to A128, which is the same number as the number of the ejection orifices 3 of the ejection orifice row 3a, are all within the range of 95% to 105% of the length calculated from Math. 2. If all 128 lines are of the predetermined lengths, the pattern evaluation flow ends normally, but in the case where there is even one vertical ruled line that is not of the predetermined length, the pattern evaluation flow ends abnormally. In the case of a normal end, in the result output processing in S310, the user is notified that the circulation state is normal, that is, the circulation is normally carried out. On the contrary, in the case of an abnormal end, in the result output processing in S310, the user is notified that there is an ejection orifice experiencing poor ejection. At this time, the user may also be notified of the defect severity and the factors considered as the main causes of the defect (poor circulation, foreign matter clogging, etc.). In this way, the image processing portion functions as a circulation inspection unit that inspects the circulation state of the liquid ejection head 10 on the basis of the inspection patterns.

Note that in the present embodiment, the length of the vertical ruled line is determined to be a predetermined length when same is within +5% of a theoretical value, but the present invention is not limited to such a configuration. The setting range may be changed according to the type of the liquid and recording medium, as well as ejection conditions. In addition, the configuration may be such that the determination is made on the basis of whether the length of the vertical ruled line is greater than or equal to a predetermined threshold value without setting an upper limit value for the predetermined length.

Note that in the above description, the inspection (evaluation) method for the liquid circulation function is described by taking the ejection orifice row 3a as an example, but the other ejection orifice rows 3b to 3d can be inspected (evaluated) in the same way.

The inspection method (circulation inspection system) for the liquid circulation function of the liquid ejection head 10 described above will be summarized. In the inspection for the liquid circulation function according to the present embodiment, first, liquid droplets are continuously ejected from all the ejection orifices 3, and the circulation of the liquid is started after the ejection is stopped. After this state is maintained for a predetermined time period, vertical ruled lines are printed by means of each ejection orifice row and taken as inspection patterns, and each vertical ruled line is evaluated. If the circulation of the liquid is normal, the length of the vertical ruled line is a predetermined length, but in the case where circulation is poor, the length of the vertical ruled line is less (or greater) than the predetermined length. The circulation state (situation) of the liquid is inspected on the basis of the difference in the formation of such inspection patterns.

According to the configuration of the present embodiment, an independent inspection pattern (vertical ruled line) is form by continuous ejection carried out by means of each ejection orifice in the ejection orifice row. Therefore, even if the configuration is such that the arrangement density of the ejection orifices in the ejection orifice row is low, the liquid droplet to be ejected is small so that the landed droplets from the adjacent ejection orifices do not overlap, and a continuous straight line parallel to the ejection orifice row cannot be printed, the inspection pattern can be printed by continuous ejection from the same ejection orifice. Thus, by evaluating the inspection patterns, the circulation state of the liquid can be properly inspected without misjudgment.

### Second Embodiment

Next, a second embodiment of a circulation inspection system that inspects the circulation state will be described. The second embodiment is different from the first embodiment in the arrangement configuration of ejection orifice 3 of the liquid ejection head 10. Hereinafter, only the differences between the configuration of the second embodiment and the configuration of the first embodiment will be described. The same constituent elements in the configurations of the first and second embodiments are represented by the same reference signs, and the description thereof will not be repeated.

The liquid ejection head 10, which is the inspection target, in the second embodiment is configured similarly to the first embodiment with one element substrate H arranged on one support member 1 as illustrated in FIG. 1A. However, in the second embodiment, the liquid ejection head 10, which is the inspection target, differs from the first embodiment in the number and arrangement density of the ejection orifices 3.

In the second embodiment, the arrangement density of the ejection orifices 3 is 600 dpi, and 512 ejection orifices 3 are arranged for one row of the ejection orifice rows. Accordingly, the distance between the centers of the adjacent ejection orifices is about 42 micrometers. The diameter of a landed dot is about 50 micrometers as in the first embodiment. In addition, although the inspection flow of the present embodiment is generally the same as the respective flows of FIG. 3 and FIG. 5 described in the first embodiment, there are differences due to different arrangement densities of the ejection orifices, so the following description will be made on the differences.

The inspection pattern of the first embodiment is formed by ejecting a liquid from all the ejection orifices 3 in one ejection orifice row, as illustrated in FIG. 4A. However, in the second embodiment, the arrangement density of the ejection orifices 3 is higher than that in the first embodiment. Accordingly, if the same ejection operation as in the first embodiment is carried out in the second embodiment to print an inspection pattern, the landed dots from adjacent ejection orifices 3 will overlap. As a result, the inspection pattern will become solid printing without gaps, making it impossible to inspect each ejection orifice. Therefore, in the second embodiment, the ejection timing of the ejection orifice 3 is controlled so that the inspection pattern is formed while being deviated in the conveying direction (X direction) of the recording medium 28.

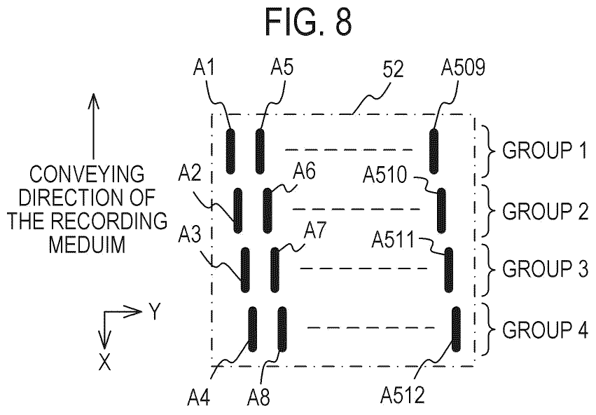

FIG. 8 is an explanatory diagram of an inspection pattern according to the second embodiment. FIG. 8 illustrates inspection patterns (vertical ruled lines A1 to A512) printed using the ejection orifices 3 of the ejection orifice row 3a of the element substrate H. Although not illustrated, below the vertical ruled lines A1 to A512 of FIG. 8 (on the upstream side of the conveying direction of the recording medium 28), inspection patterns printed using the ejection orifice row 3b, the ejection orifice row 3c, and the ejection orifice row 3d follow. Inspection patterns and the like will be described below by taking the ejection orifice row 3a as an example, but same is also applicable to other ejection orifice rows 3b to 3d.

The inspection pattern formed by ejecting the liquid from each ejection orifice 3 is the same vertical ruled lines as in the first embodiment. In the second embodiment, instead of carrying out ejection from all ejection orifices 3 in the same ejection orifice row at the same timing, all ejection orifices 3 are divided into four groups, namely, Group 1, Group 2, Group 3, Group 4, and ejection is carried out by staggering the timing in a group-by-group manner. In other words, in the first embodiment, all the inspection patterns of the ejection orifice row 3a are located at the same position in the X direction and lined up in a row in the Y direction, whereas in the second embodiment, the inspection patterns of the ejection orifice row 3a are printed while being deviated in the X direction.

Group 1 includes the ejection orifice 3 at one end of the ejection orifice row 3a and every fourth ejection orifice 3 thereafter. In other words, Group 1 includes 1st+4n (n=0, 1, . . . , 127)th ejection orifices 3 from one end of the ejection orifice row 3a. Similarly, Group 2 includes the ejection orifice 3 at the second position from one end of the ejection orifice row 3a and every fourth ejection orifice 3 thereafter, i.e., the 2nd+4n (n=0, 1, . . . , 127)th ejection orifices 3 from one end of the ejection orifice row 3a. Group 3 includes the ejection orifice 3 at the third position from one end of the ejection orifice row 3a and every fourth ejection orifice 3 thereafter, i.e., the 3rd+4n (n=0, 1, . . . 127)th ejection orifices 3 from one end of the ejection orifice row 3a. Group 4 includes the ejection orifice 3 at the fourth position from one end of the ejection orifice row 3a and every fourth ejection orifice 3 thereafter, i.e., the 4th+4n (n=0, 1, . . . , 127) th ejection orifices 3 from one end of the ejection orifice row 3a. By staggering the ejection timing according to the groups in this manner, an inspection pattern can be printed in which the landed dots from adjacent ejection orifices 3 do not overlap.

The time for staggering the ejection timing between groups is set to 14 times the ejection time interval T calculated from Math. 1. In other words, the ejection timing of Group 2 is 14T after the ejection timing of the Group 1. In addition, the ejection timing of Group 3 is 28T after the ejection timing of Group 1. Moreover, the ejection timing of Group 4 is 42T after the ejection timing of Group 1. Thus, a blank part between groups (for example, a blank part in the X direction between the vertical ruled line A1 and the vertical ruled line A2) is the length of 4 droplets of the landed droplets constituting the vertical ruled line.

Note that the number of groups is not limited to 4, and may be 8 or 16. In addition, the number of groups can also be reduced depending on the arrangement density of the ejection orifices 3. In addition, the inspection patterns may be formed in the order of Group 1, Group 3, Group 2, and Group 4, for example, instead of being formed in the order of Group 1, Group 2, Group 3, and Group 4.

In the second embodiment, the evaluation flow of the inspection pattern is generally the same as the evaluation flow of the first embodiment illustrated in FIG. 5. However, in the setting of the image processing region in S501, it is necessary to set an image processing region 52 that is larger than the image processing region 51 set in the first embodiment. This is because the image processing region 52 is formed such that all the landed dots (vertical ruled lines A1 to A512) that are ejected from all the ejection orifices 3 of the ejection orifice row 3a are subjected to image processing.

The processing subsequent to S502 is carried out in a group-by-group manner the same as that in the first embodiment. Accordingly, in S506, in the case where the lengths of all (512) vertical ruled lines are predetermined lengths (within a predetermined range), the evaluation flow ends normally, whereas in the case where there is even one vertical ruled line that is not of the predetermined length, the evaluation flow ends abnormally.

As described above, in the case of a configuration like that in the second embodiment, where the arrangement density of the ejection orifices 3 is high and simultaneous ejection of liquid from all the ejection orifices in the ejection orifice row may lead to solid printing, it is preferable to divide the ejection orifices into groups and staggering the timing in a group-by-group manner. Thus, inspection patterns (vertical ruled lines) printed (formed) by means of different ejection orifices will not overlap with each other, and independent inspection patterns corresponding to each ejection orifice will be printed (formed). Accordingly, the circulation state of the liquid can be properly inspected for each ejection orifice.

### Third Embodiment

Next, a third embodiment of a circulation inspection system that inspects the circulation state will be described. The third embodiment is different from the first embodiment in that the evaluation flow of the inspection pattern includes a mis-alignment inspection process for inspecting the amount of mis-alignment. Hereinafter, only the differences between the configuration of the third embodiment and the configurations of the first and second embodiments will be described. In the third embodiment, the same constituent elements in the configurations of the first embodiment or the second embodiment are represented by the same reference signs, and the description thereof will not be repeated.

The liquid ejection head 10, which is the inspection target, in the third embodiment is the same as that in the second embodiment. In other words, the liquid ejection head 10 has a configuration as illustrated in FIG. 1A, where the arrangement density of ejection orifices 3 is 600 dpi, and 512 ejection orifices 3 are arranged in one row of the ejection orifice rows. The inspection flow of the third embodiment is the same as the flow of FIG. 3 described in the first embodiment, but the evaluation flow of the inspection pattern has several pieces of additional processing compared to the flow illustrated in FIG. 5. Next, the additional processing in the evaluation flow of the inspection pattern will be described.

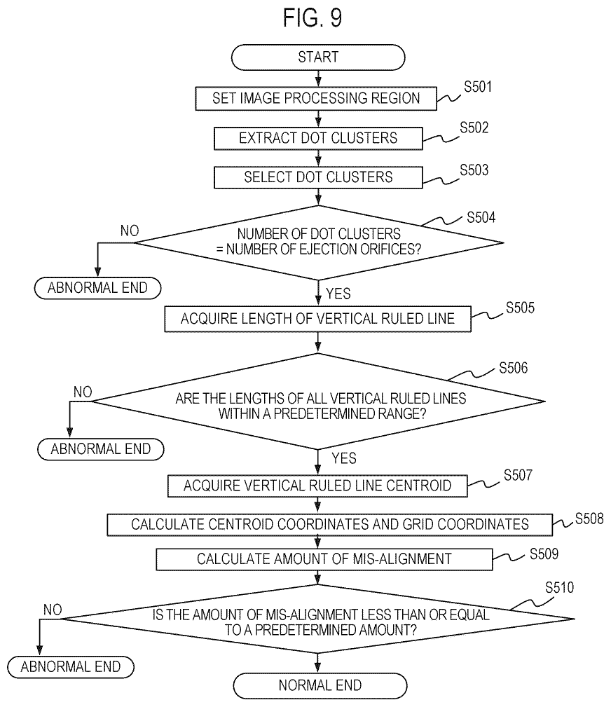

FIG. 9 is a flowchart illustrating an evaluation flow of an inspection pattern according to the third embodiment. In the third embodiment, following the processing for inspecting the circulation state of the liquid described in the first embodiment, processing for inspecting the amount of mis-alignment of the landing position is added. S501 to S506 are the same as those in the first embodiment and thus will not be described further, and steps from S507 will be described. In addition, since the inspection method for the amount of mis-alignment is the same for each of the ejection orifice rows 3a to 3d, the following description will be made by taking the ejection orifice row 3a as an example, and the description for the other ejection orifice rows 3b to 3d will be omitted.

Through the processing up to S506, it is determined whether or not the lengths of all 512 inspection patterns (vertical ruled lines) illustrated in FIG. 8 are predetermined lengths (within a predetermined range). Then, in the third embodiment, when it is determined in S506 that the lengths of all the inspection patterns are the predetermined lengths, the evaluation flow continues, and the process proceeds to the mis-alignment inspection process of S507 and subsequent steps.

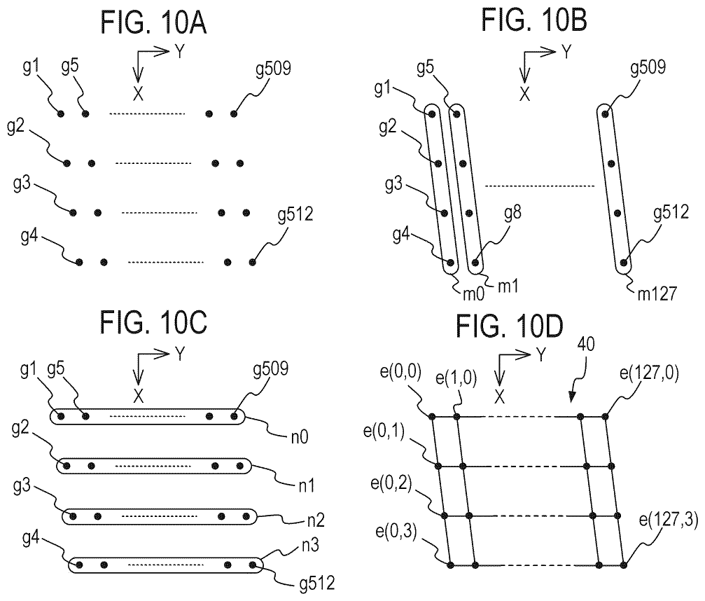

In S507, the image processing portion calculates the centroid of each of the vertical ruled lines A1 to A512 (vertical ruled line centroid) through image processing. FIG. 10A to FIG. 10D are explanatory diagrams of a method for calculating grid coordinates used for inspecting the amount of mis-alignment according to the third embodiment. FIG. 10A to FIG. 10D illustrate centroids g1 to g512 indicating the centroid positions of the vertical ruled lines A1 to A512, respectively. The centroid is located approximately at the center in the X and Y directions of the corresponding vertical ruled line.

FIG. 10A is a schematic diagram illustrating a state after execution of vertical ruled line centroid acquisition processing in S507. The example illustrated in FIG. 10A is an example in which the vertical ruled lines A1 to A512 are printed at ideal positions. In this case, four rows of centroids arranged in the Y direction are formed. These rows are positioned to be deviated from each other in the Y direction. In other words, 128 rows extending obliquely in the X direction, each composed of four centroids, are formed.

Next, in S508, the image processing portion calculates the centroid coordinates of the centroids g1 to g512 of the vertical ruled lines and the grid coordinates indicating ideal positions of the centroids g1 to g512. The vertical ruled lines A1 to A512 actually printed are not necessarily all printed at ideal positions. This is because the printing position (the landing position of the liquid on the recording medium) will be deviated to some extent due to various factors such as the direction in which the liquid is ejected and the accuracy of the position in which the ejection orifice 3 is formed. Therefore, in the third embodiment, not only is the circulation state of the liquid inspected, but also the amount of mis-alignment representing the deviation of the printing position is inspected. The grid coordinates calculated in S508 serve as a reference when calculating the amount of mis-alignment, and the amount of mis-alignment is equivalent to the amount of deviation between the centroid coordinates and the grid coordinates.

A method for calculating the grid coordinates will be described in detail. First, the centroids g1 to g512 are grouped into a set of four from one end in the Y direction, meaning groups like g1 to g4, g5 to g8, . . . , g509 to g512. In this way, grouping, in which the centroids g1 to g512 are divided into groups of four centroids arranged linearly in a direction crossing the X direction and the Y direction is defined as first grouping. FIG. 10B is a schematic diagram illustrating a state after execution of the first grouping. Then, each of the groups divided through the first grouping is referred to as oblique groups m0 to m127. Each of the oblique groups m0 to m127 is composed of four centroids that are linearly arranged in the lower right direction of FIG. 10B.

The oblique group m0 located on the leftmost side (one end side in the Y direction) in FIG. 10B includes the centroids g1 to g4. The oblique group ml adjacent to the right side of the oblique group m0 includes centroids g5 to g8. The oblique group m127 located on the rightmost side (the other end side in the Y direction) in FIG. 10B includes the centroids g509 to g512. Hereinafter, numerical values 0 to 127 given to the oblique groups' reference signs m0 to m127 will also be referred to as oblique group numbers.

Then, the centroids g1 to g512 are grouped into four groups according to their positions in the X direction. In this way, grouping in which the centroids g1 to g512 are divided into a group of 128 centroids arranged linearly in the Y direction is defined as second grouping. FIG. 10C is a schematic diagram illustrating a state after execution of the second grouping. Then, each of the groups divided through the second grouping is referred to as horizontal groups n0 to n3. Hereinafter, numerical values 0 to 3 given to the horizontal groups' reference signs n0 to n3 will also be referred to as horizontal group numbers.

Next, the coordinates of the centroids g1 to g512 are calculated. For convenience of explanation, the centroids g1 to g512 of the vertical ruled lines in FIG. 10A to FIG. 10C are annotated as the centroid e(m, n), respectively, where m indicates the oblique group number mentioned above, and n indicates the horizontal group number. FIG. 10D illustrates the state after the centroids g1 to g127 are annotated in the form of e(m, n), respectively. For example, the centroid g1 is annotated as e(0, 0) since the oblique group number thereof is 0 and the horizontal group number thereof is 0, the centroid g512 is annotated as e(127, 3) since the oblique group number thereof is 127 and the oblique group number thereof is 3.

FIG. 10D illustrates a grid 40 formed by connecting vertical ruled line centroids adjacent to each other when the vertical ruled lines A1 to A512 are formed at ideal positions. In other words, the intersection points in the grid 40 (grid intersection points) indicates the ideal positions of the centroids. The grid 40 has a reference position at the closest intersection point to the centroid e(0, 0) of the vertical ruled line A1 in the grid, and this intersection point is annotated as k(0, 0). The X coordinate in the grid intersection point k(0, 0), or Xk(0, 0), and the Y coordinate, or Yk(0, 0), can be calculated from the following Math. 3 and Math. 4.

$$Xk ( 0 , 0 ) = ( {\sum }_{g = 1}^{512} X g - 56 M \sqrt[3]{P} {\sum }_{g = 1}^{512} n ) / 512 \qquad [ Math . 3 ]$$

$$Yk ( 0 , 0 ) = \{ {\sum }_{g = 1}^{512} Yg - 42.3 {\sum }_{g = 1}^{512} ( 3 m + n ) \} / 512 \qquad [ Math . 4 ]$$

Here, each symbol indicates as follows.
g: the centroid number of the vertical ruled line
m: the number of the oblique group including the centroid g
n: the number of the horizontal group including the centroid g
Xg: the X coordinate of the centroid g
Yg: the Y coordinate of the centroid g

Note that, as in Math. 1 and Math. 2, M is the spread rate, and P is the ejection amount. In addition, the units of the calculation results of Math. 3 and Math. 4 are micrometers.

For a grid intersection point k(m, n) with the oblique group number m and the horizontal group number n, assuming that its X coordinate is Xk(m, n) and Y coordinate is Yk(m, n), the X coordinate and Y coordinate of each grid intersection point can be calculated from the following Math. 5 and Math. 6.

$$Xk ( m , n ) = Xk ( 0 , 0 ) + 56 nM \sqrt[3]{P} \qquad [ Math . 5 ]$$

$$Yk ( m , n ) = Yk ( 0 , 0 ) + 42.3 ( 3 m + n ) \qquad [ Math . 6 ]$$

The units of the calculation results of Math. 5 and Math. 6 are micrometers.

According to the above procedure, in S508, the image processing portion calculates the centroid coordinates of the centroids g1 to g512 of the vertical ruled lines A1 to A512 and the coordinates of the intersection points in the grid 40 indicating the ideal positions of the centroids g1 to g512.

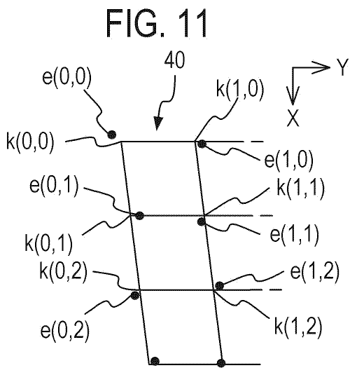

Next, in S509, the image processing portion calculates the amount of mis-alignment of each vertical ruled line centroid from the coordinates of each intersection point in the grid 40 and the centroid coordinates of each vertical ruled line. FIG. 11 is an explanatory diagram of a method for calculating the amount of mis-alignment, which is an enlarged schematic diagram of a part of the grid 40 and the vertical ruled line centroids.

The amount of mis-alignment of the vertical ruled line centroid is represented by an X direction distance and a Y direction distance between the centroid e(m, n) of the vertical ruled line and the grid intersection point k(m, n) having the same oblique group number m and horizontal group number n. For example, the amount of mis-alignment of the centroid e(1, 2) of the vertical ruled line A7 is obtained by subtracting the coordinates of the grid intersection point k(1, 2) from the coordinates of the centroid e(1, 2). Specifically, the X coordinate of the centroid e(m, n) is Xe(m, n) and the Y coordinate thereof is Ye(m, n), the amount of mis-alignment of the centroid e(1, 2) is calculated as |Xe(1,2)−Xk(1,2)| and |Ye(1,2)−Yk(1,2)|.

Finally, in S510, the image processing portion determines whether or not the amount of mis-alignment of each vertical ruled line centroid is less than or equal to a predetermined amount. The predetermined amount is an amount (threshold value) related to printing quality, which is set to 40 micrometers in the present embodiment. In the third embodiment, it is determined that there is no problem when both the amount of mis-alignment (amount of deviation) in the X direction and the amount of mis-alignment (amount of deviation) in the Y direction are less than or equal to the predetermined amount. Accordingly, when the amounts of mis-alignment, in the X direction and Y direction, of the centroids g1 to g512 of all vertical ruled lines A1 to A512 are less than or equal to a predetermined amount, the evaluation flow ends normally. On the contrary, if the one or more amounts of mis-alignment is greater than the predetermined amount, the evaluation flow ends abnormally.

Note that in the case of an abnormal end, for example, the user may be notified of which ejection orifice 3 forms a vertical ruled line whose centroid has an amount of mis-alignment greater than the predetermined value. In addition, the numerical values of each amount of mis-alignment can be summarized and transmitted to another external terminal regardless of a normal end or an abnormal end. Furthermore, instead of calculating the amounts of mis-alignment in the X direction and Y direction, respectively, the shortest distance between the centroid e(m, n) and the grid intersection point k(m, n) can also be calculated as the amount of mis-alignment and used for determination.

As described above, according to the configuration of the third embodiment, the amount of mis-alignment can be inspected using the inspection patterns printed for inspecting the circulation state of the liquid. Thus, even if in the case where the amount of mis-alignment needs to be inspected, there is no need to print patterns for inspection of the amount of mis-alignment since the inspection of the amount of mis-alignment can be carried out at the same time as the circulation state inspection. Therefore, the ink consumption can be reduced and the inspection time can be shortened.

The present disclosure can further develop conventional technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177322, filed Oct. 9, 2024, which is hereby incorporated by reference herein in its entirety.

What is claimed is:

1. A liquid ejection apparatus, comprising:
a liquid ejection head which has: an ejection orifice row formed by a plurality of ejection orifices that are arranged in a first direction and for ejecting a liquid, and a pressure chamber that communicates with the ejection orifice and has a pressure generation element configured to generate a pressure for ejecting a liquid from the ejection orifice;
a circulation unit configured to circulate the liquid inside the pressure chamber between inside and outside of the pressure chamber;
a drive control portion which controls operations of the liquid ejection head and the circulation unit, the drive control portion being configured to be capable of executing: (i) an ejection suspension operation to suspend liquid ejection from the ejection orifice; (ii) a circulation operation to circulate the liquid inside the pressure chamber that communicates with the ejection orifice between the inside and outside of the pressure chamber; and (iii) a printing operation to print an elongated inspection pattern in a second direction intersecting the first direction on a recording medium, by ejecting the liquid a plurality of times from the same ejection orifice; and
a circulation inspection unit for inspecting a circulation state of the liquid ejection head on the basis of a length of the inspection pattern in the second direction.

2. The liquid ejection apparatus according to claim 1,
wherein the inspection pattern is formed by a plurality of landed droplets, formed by the liquid ejected from the ejection orifice and landing on the recording medium, the landed droplet overlapping with each other in the second direction.

3. The liquid ejection apparatus according to claim 2,
wherein the inspection pattern is formed such that one fourth to one half of a diameter of the landed droplet overlaps with an adjacent landed droplet.

4. The liquid ejection apparatus according to claim 1,
wherein in a case where the length of the inspection pattern in the second direction is shorter than a predetermined threshold value, the liquid ejection apparatus notifies a user that the circulation is poor.

5. The liquid ejection apparatus according to claim 1,
wherein the circulation inspection unit inspects the circulation state of the liquid ejection head on the basis of a number of the inspection patterns printed on the recording medium, in addition to the length of the inspection pattern in the second direction.

6. The liquid ejection apparatus according to claim 1,
wherein the drive control portion executes a viscosity control operation to control the viscosity of the liquid inside the ejection orifice before the ejection suspension operation.

7. The liquid ejection apparatus according to claim 1,
wherein in the printing operation, the liquid is ejected at substantially the same timing from all the ejection orifices forming the ejection orifice row.

8. The liquid ejection apparatus according to claim 1,
wherein in the printing operation, the liquid is ejected at different timings from the two ejection orifices adjacent to each other in the first direction.

9. The liquid ejection apparatus according to claim 1,
wherein the circulation inspection unit is capable of executing a mis-alignment inspection to inspect an amount of mis-alignment of a landing position of the liquid from the ejection orifice on the basis of the inspection pattern.

10. The liquid ejection apparatus according to claim 9,
wherein in the mis-alignment inspection, the amount of mis-alignment is inspected on the basis of a centroid position of the inspection pattern.

11. A circulation inspection apparatus, comprising:
a support portion which supports a liquid ejection head, the liquid ejection head having an ejection orifice row formed by a plurality of ejection orifices that are arranged in a first direction and for ejecting a liquid, and a pressure chamber that communicates with the ejection orifice and has a pressure generation element configured to generate a pressure for ejecting a liquid from the ejection orifice;
a drive control portion which controls an operation of the liquid ejection head supported by the support portion, the drive control portion being configured to be capable of executing: (i) an ejection suspension operation to suspend liquid ejection from the ejection orifice; (ii) a circulation operation to circulate the liquid inside the pressure chamber that communicates with the ejection orifice between inside and outside of the pressure chamber; and (iii) a printing operation to print an elongated inspection pattern in a second direction intersecting the first direction on a recording medium, by ejecting the liquid a plurality of times from the same ejection orifice; and
a circulation inspection unit for inspecting a circulation state of the liquid ejection head on the basis of a length of the inspection pattern in the second direction.

12. The circulation inspection apparatus according to claim 11, further comprising:
a notifier for notifying a user that the circulation is poor in a case where the length of the inspection pattern in the second direction is shorter than a predetermined threshold value.
